(19) United States
(12) Patent Application Publication
(10) Pub. No.: US 2014/0280444 A1
(43) Pub. Date: Sep. 18, 2014

(54) SCALABLE DATA TRANSFER IN AND OUT OF ANALYTICS CLUSTERS

(71) Applicant: International Business Machines Corporation, Armonk, NY (US)

(72) Inventors: Dean Hildebrand, San Jose, CA (US); Prasenjit Sarkar, San Jose, CA (US)

(73) Assignee: International Business Machines Corporation, Armonk, NY (US)

(21) Appl. No.: 14/016,389

(22) Filed: Sep. 3, 2013

Related U.S. Application Data
(63) Continuation of application No. 13/826,150, filed on Mar. 14, 2013.

(51) Int. Cl. H04L 29/08

(52) U.S. Cl. CPC H04L 67/02
USPC 709/201

(57) ABSTRACT

Embodiments of the invention relate to analytics clusters, and to a network layer application to efficiently supporting read and write requests in the cluster. In one aspect, one or more compute nodes within a region of the cluster are designated to support the request, and based upon the designation, the request is directly communicated between a requesting agent external to the cluster and the supporting compute node(s) via a regional hardware element. The direct communication mitigates the functionality of the head node(s) supporting the compute node(s).

### CROSS REFERENCE TO RELATED APPLICATION(S)

This application is a continuation patent application claiming the benefit of the filing date of U.S. patent application Ser. No. 13/826,150 filed on Mar. 14, 2013 and titled “Scalable Data Transfer In And Out Of Analytics Clusters,” now pending, which is hereby incorporated by reference.

### BACKGROUND

The present invention relates to data distribution in an analytics cluster. More specifically, the invention relates to a network application for directing data from a source analytics cluster to a target analytics cluster sensitive to performance locality.

In an analytics cluster, data is typically stored in a local storage file system. Each node in the analytics cluster has a local storage file system. Data communicated in and out of the cluster flows through one or more head nodes. Details of the architecture of the cluster, including the quantity of servers, network topology, etc., are not visible to an external source. Communications with the cluster are directed through the head node(s), and from the head node(s) through to the supporting compute node(s) of the cluster. Specifically, the prior art head nodes process the read and write requests so that all of the data for the request is processed through the head node. Efficiency of the request is limited to the space and processing capacity on the head node. Accordingly, the head node(s) of the cluster prevent direct read and write transactions on compute nodes from an external source.

### BRIEF SUMMARY

This invention comprises a method for supporting direct I/O access for read and write transactions with an analytics cluster.

In one aspect, read and write transactions within an analytics cluster are intelligently supported. The analytics cluster includes a plurality of compute nodes separated into regions, with routing information for each region stored in a regional hardware element. Data is directed through the network layer, e.g. the regional hardware element, with the direction in response to a directive from a head node to support communication to one of the plurality of compute nodes in at least one region. This direction distributes the data to the cluster. The data communication may be in the form of a read request or a write request. For a write request, data is transferred directly to a select compute node responsive to the data direction, and for a read request the transfer is directed through the regional hardware element in the select region. Accordingly, read and write transactions in an analytics cluster are intelligently supported through distribution of data at the network layer.

Other features and advantages of this invention will become apparent from the following detailed description of the presently preferred embodiment of the invention, taken in conjunction with the accompanying drawings.

### BRIEF DESCRIPTION OF THE SEVERAL VIEWS OF THE DRAWINGS

The drawings referenced herein form a part of the specification. Features shown in the drawings are meant as illustrative of only some embodiments of the invention, and not of all embodiments of the invention unless otherwise explicitly indicated.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 is a block diagram of a region within the analytics cluster.

FIG. 5 is a block diagram of a multi-region analytics cluster.

FIG. 6 is a flow chart illustrating a method for a network application of bypassing a head node for a write request.

FIG. 7 is a flow chart illustrating a method for a network application bypassing a head node for a read request.

### DETAILED DESCRIPTION

It will be readily understood that the components of the present invention, as generally described and illustrated in the Figures herein, may be arranged and designed in a wide variety of different configurations. Thus, the following detailed description of the embodiments of the apparatus, system, and method of the present invention, as presented in the Figures, is not intended to limit the scope of the invention, as claimed, but is merely representative of selected embodiments of the invention.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, such as examples of a profile manager, a cluster manager, a partition manager, a merge manager, an activity manager, an assignment manager, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

The functional unit(s) described in this specification has been labeled with tools in the form of managers. A manager may be implemented in programmable hardware devices such as field programmable gate arrays, programmable array logic, programmable logic devices, or the like. The managers may also be implemented in software for processing by various types of processors. An identified manager of executable code may, for instance, comprise one or more physical or logical blocks of computer instructions which may, for instance, be organized as an object, procedure, function, or other construct. Nevertheless, the executable of an identified manager need not be physically located together, but may comprise disparate instructions stored in different locations which, when joined logically together, comprise the managers and achieve the stated purpose of the managers.

Indeed, a manager of executable code could be a single instruction, or many instructions, and may even be distributed over several different code segments, among different applications, and across several memory devices. Similarly, operational data may be identified and illustrated herein within the manager, and may be embodied in any suitable form and organized within any suitable type of data structure. The operational data may be collected as a single data set, or may be distributed over different locations including over different storage devices, and may exist, at least partially, as electronic signals on a system or network.

A cloud computing environment is service oriented with a focus on statelessness, low coupling, modularity, and semantic interoperability. At the heart of cloud computing is an infrastructure comprising a network of interconnected nodes. Referring now to FIG. 1, a schematic of an example of a cloud computing node is shown. Cloud computing node (110) is only one example of a suitable cloud computing node and is not intended to suggest any limitation as to the scope of use or functionality of embodiments of the invention described herein. Regardless, cloud computing node (110) is capable of being implemented and/or performing any of the functionality set forth hereinabove. In cloud computing node (110) there is a computer system/server (112), which is operational with numerous other general purpose or special purpose computing system environments or configurations. Examples of well-known computing systems, environments, and/or configurations that may be suitable for use with computer system/server (112) include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server (112) may be described in the general context of computer system-executable instructions, such as program modules, being executed by a computer system. Generally, program modules may include routines, programs, objects, components, logic, data structures, and so on that perform particular tasks or implement particular abstract data types. Computer system/server (112) may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server (112) in cloud computing node (110) is shown in the form of a general-purpose computing device. The components of computer system/server (112) may include, but are not limited to, one or more processors or processing units (116), a system memory (128), and a bus (118) that couples various system components including system memory (128) to processor (116). Bus (118) represents one or more of any of several types of bus structures, including a memory bus or memory controller, a peripheral bus, an accelerated graphics port, and a processor or local bus using any of a variety of bus architectures. By way of example, and not limitation, such architectures include an Industry Standard Architecture (ISA) bus, a Micro Channel Architecture (MCA) bus, an Enhanced ISA (EISA) bus, Video Electronics Standards Association (VESA) local bus, and a Peripheral Component Interconnects (PCI) bus. A computer system/server (112) typically includes a variety of computer system readable media. Such media may be any available media that is accessible by a computer system/server (112), and it includes both volatile and non-volatile media, and removable and non-removable media.

System memory (128) can include computer system readable media in the form of volatile memory, such as random access memory (RAM) (130) and/or cache memory (132). Computer system/server (112) may further include other removable/non-removable, volatile/non-volatile computer system storage media. By way of example only, storage system (134) can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus (18) by one or more data media interfaces. As will be further depicted and described below, memory (28) may include at least one program product having a set (e.g., at least one) of program modules that are configured to carry out the functions of embodiments of the invention.

Program/utility (140), having a set (at least one) of program modules (142), may be stored in memory (128) by way of example, and not limitation, as well as an operating system, one or more application programs, other program modules, and program data. Each of the operating systems, one or more application programs, other program modules, and program data or some combination thereof, may include an implementation of a networking environment. Program modules (142) generally carry out the functions and/or methodologies of embodiments of the invention as described herein.

Computer system/server (112) may also communicate with one or more external devices (114), such as a keyboard, a pointing device, a display (124), etc.; one or more devices that enable a user to interact with computer system/server (112); and/or any devices (e.g., network card, modem, etc.) that enable computer system/server (112) to communicate with one or more other computing devices. Such communication can occur via Input/Output (I/O) interfaces (122). Still yet, computer system/server (112) can communicate with one or more networks such as a local area network (LAN), a general wide area network (WAN), and/or a public network (e.g., the Internet) via network adapter (120). As depicted, network adapter (120) communicates with the other components of computer system/server (112) via bus (118). It should be understood that although not shown, other hardware and/or software components could be used in conjunction with computer system/server (112). Examples, include, but are not limited to: microcode, device drivers, redundant processing units, external disk drive arrays, RAID systems, tape drives, and data archival storage systems, etc.

Referring now to FIG. 2, illustrative cloud computing environment (250) is depicted. As shown, cloud computing environment (250) comprises one or more cloud computing nodes (210) with which local computing devices used by cloud consumers, such as, for example, personal digital assistant (PDA) or cellular telephone (254A), desktop computer (254B), laptop computer (254C), and/or automobile computer system (254N) may communicate. Nodes (210) may communicate with one another. They may be grouped (not shown) physically or virtually, in one or more networks, such as Private, Community, Public, or Hybrid clouds as described hereinabove, or a combination thereof. This allows cloud computing environment (250) to offer infrastructure, platforms and/or software as services for which a cloud consumer does not need to maintain resources on a local computing device. It is understood that the types of computing devices (254A)-(254N) shown in FIG. 2 are intended to be illustrative only and that computing nodes (210) and cloud computing environment (250) can communicate with any type of computerized device over any type of network and/or network addressable connection (e.g., using a web browser).

Referring now to FIG. 3, a set of functional abstraction layers provided by cloud computing environment (250) is shown. It should be understood in advance that the components, layers, and functions shown in FIG. 3 are intended to be illustrative only and embodiments of the invention are not limited thereto. As depicted, the following layers and corresponding functions are provided: hardware and software layer (360), virtualization layer (362), management layer (364), and workload layer (366). The hardware and software layer (360) includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer (362) provides an abstraction layer from which the following examples of virtual entities may be provided: virtual servers; virtual storage; virtual networks, including virtual private networks; virtual applications and operating systems; and virtual clients.

In one example, management layer (364) may provide the following functions: resource provisioning, metering and pricing, user portal, service level management, and SLA planning and fulfillment. The functions are described below. Resource provisioning provides dynamic procurement of computing resources and other resources that are utilized to perform tasks within the cloud computing environment. Metering and pricing provides cost tracking as resources that are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provides pre-arrangement for, and procurement of, cloud computing resources for which a future requirement is anticipated in accordance with an SLA.

Workloads layer (366) provides examples of functionality for which the cloud computing environment may be utilized. An example of workloads and functions which may be provided from this layer includes, but is not limited to, organization and management of data objects within the cloud computing environment. In the shared pool of configurable computer resources described herein, hereinafter referred to as a cloud computing environment, files may be shared among users within multiple data centers, also referred to herein as data sites. A series of mechanisms are provided within the shared pool to provide organization and management of data storage. A computer storage system provided within shared pool of resources contains multiple levels known as storage tiers. Each storage tier is arranged within a hierarchy and is assigned a different role within the hierarchy. It should be understood that this hierarchically organized storage system maintains a flexible tier definition, such that tiers can be managed as a singleton on every node or tiers can be managed globally across all or a subset of the nodes in the system.

An analytics cluster employs compute nodes to support read and write transactions. Within the cluster, the compute nodes may be organized into regions, with each region having a minimum of one compute cluster. The compute node may be a hardware machine or a virtual machine. FIG. 4 is a block diagram of a region (400) within the analytics cluster. As shown, the region (400) is provided with two compute nodes, node₀ (410) and node₁ (420). Although only two compute nodes are shown and described, the region may include additional compute nodes. Each compute node includes a processing unit in communication with memory. As shown, node₀ (410) includes a processing unit (412) in communication with memory (414), and node₁ (420) includes a processing unit (422) in communication with memory (424). The quantity of compute nodes shown and described is for descriptive purposes. Each compute node (410) and (420) includes storage (426) and (446), respectively. Storage may be in the form of a disk, solid state drive, etc. The compute nodes support received read and write transactions.

In addition to the compute nodes (410) and (420), the region (400) includes one or more head nodes (430), a head node manager (440), a direction manager (450), and a regional hardware element (445). The head node (430) is a form of a compute node that file access clients access to read or write files and/or directories. The head node (430) is provided with a processing unit (432) in communication with memory (434) and local data storage (436). The head node manager (440) determines available head nodes in the cluster to support a read or write request from outside the region. The direction manager (450) is a process that head nodes use to determine a compute node to which a read or write request should be forwarded. Specifically, the direction manager (450) communicates with the head node(s) (430) to direct the request to one or more compute node (410) and (420) in the region that can support the request. The regional hardware element (445) is a physical device within the region and is employed to store request routing information. More specifically, data in support of the request is directed through the regional hardware element (445). In one embodiment, the regional hardware element may be in the form of a switch, an adapter, or a device driver. Accordingly, each region includes a head node (430), a direction manager (450), at least one compute node (410), and/or possibly a sub-region, and a regional hardware element (445).

FIG. 4 is a schematic illustration of one region within an analytics cluster, and the minimum components of the region. The analytics cluster may be configured with multiple regions, each region having at least the minimum components shown in FIG. 4. In a multiple region configuration, the regions may be nested, e.g. a region within a region, or non-nested. Regardless of the nesting, any form of a multi-region cluster includes a head node manager. FIG. 5 is a block diagram of a multi-region analytics cluster (500). As shown, the cluster is comprised of a plurality of regions, region₀ (510), region₁ (520), region₂ (530), and region₃ (540). Each region is provided with a head node (512), (522), (532), and (542). Similarly, each region is provided with a head node manager (556), (566), (576), and (586), respectively, and a direction manager (558), (568), (578), and (588), respectively. As described above in FIG. 4, each head node includes a processing unit in communication with memory and local data storage. Head node (512) is includes processing unit (514) in communication with memory (516) and local data storage (518); head node (522) includes processing unit (524) in communication with memory (526) and local data storage (528); and head node (532) includes processing unit (534) in communication with memory (536) and local data storage (538).

Each head node (512), (522), (532), and (542) is in communication with the compute node(s) in their respective regions. For illustrative purposes, each region is shown with two compute nodes, although in one embodiment each region may be configured with a minimum of one compute node, or a plurality of compute nodes. In addition, each region (510), (520), (530), and (540), includes a regional hardware element (554), (564), (574), and (584), respectively. The regional hardware elements each function to store request routing information for the region and to support data direction through the stored information.

As shown regional hardware element (554) is in communication with head node (512), which is in communication with compute nodes (550) and (552) in region₀ (510); regional hardware element (564) is in communication with head node (522), which is in communication with compute nodes (560) and (562) in region₁ (520); regional hardware element (574) is in communication with head node (532), which is in communication with compute nodes (570) and (572) in region₂ (530); and regional hardware element (584) is in communication with head node (542), which is in communication with compute nodes (580) and (582) in region₃ (540). In the multi-region cluster, the multiple head nodes are supported by a head node manager (590), a direction manager (592), and regional hardware element (594). The head node manager (590) determines a list of available head nodes in the cluster to support the request and stores associated list information local to the regional hardware element (594). For each file or directory, the head node manager (590) returns a mapping of the directory to a head node or a mapping of byte ranges and their associated head node to the regional hardware element (594). In one embodiment, the regional topology is stored in the regional hardware element (594). The functionality of the direction manager (592) is an expanded form of the single region direction manager (450), with the direction manager (592) to determine a region or a compute node to support the request. The file access client can be executed in one of several different places, including an analytics cluster head node, or a node outside of the analytics cluster with transfer direction through the regional hardware element(s). In one embodiment, the data transfer in support of the request may be from one analytics cluster to another analytics cluster, wherein the file access client may be one of the regional hardware elements. Accordingly, the regional hardware element (594) functions as a point of communication for external file access clients that request to read or write data to the cluster, e.g. at least one region within the cluster.

Congestion within a head node of an analytics cluster is reduced by a reduction in the work load of the head node. FIG. 6 is a flow chart (600) illustrating a sample write request at the network layer that employs one or more switches, e.g. regional hardware elements, within the hardware of the cluster in receipt of the request. The write request is received by a head node manager for the cluster (602), and the head node manager and direction manager ascertain the region layout for the cluster (604). The region layout pertains to routing information for the cluster. The head node manager is in communication with a first switch, and the head node manager places the layout routing information for the cluster in the first switch (606). With the cluster topography in the switch, it is determined if the cluster includes two or more regions of compute nodes (608). A negative response indicates that the cluster is a single region cluster (610), and a positive response indicates that the cluster is a multi-region cluster.

For a single region cluster (610), the direction manager for the region determines which compute node(s) in the region can support the request (612), and the direction manager receives the support information and places the support information in the first switch (614). Once the first switch has the routing information for the request, the request is forwarded via the switch(es) directly to the final compute node(s), all while skipping the head nodes (616). Accordingly, the routing information as ascertained by the direction manager is placed in the switch so that the data in support of the request is directed through the switch.

If however, there is more than one region in the cluster, the head node manager communicates with the direction manager to determine which region, sub-region, or compute node(s) should be employed to support the request (618). The region topology is stored in a regional switch (620). The direction manager determines which compute node(s) for the region can support the request (622). In one embodiment, the selection is based on workload characteristics and/or physical region attributes. The selection of compute nodes for the request is placed in a second switch local to the select region (624). In one embodiment, each region has a switch. Once the second switch has the routing information for the request, the request is forwarded via the first and second switches directly to the final compute node(s) (626), all while skipping the head nodes. The process of determining the layout for a region and placing the layout and compute node information for the request in a regional switch is repeated until the appropriate compute node(s) in the cluster to support the request is ascertained. Once all switches along a path have routing information for the request, the request is forwarded along to a final destination compute node while bypassing all of the head nodes in the cluster. Accordingly, the switches are provided with the layout information and the assigned compute node(s) to support the request, thereby facilitating the request while bypassing the head node(s) for the region(s).

The functionality of the switches is shown in FIG. 6 to support a write request. The switches may also be employed to support a read request, in a similar manner to the process demonstrated in FIG. 6. More specifically, the switches are provided with an architectural layout and topology for the respective region(s). Communications to support the request are directed through the switches thereby bypassing the head node(s) for the region(s).

FIG. 7 is a flow chart (700) illustrating a method for one or more regional hardware elements to support a read request by transferring data from one or more compute nodes directly to a requesting client. Direction of the request is supported by the regional hardware elements, thereby mitigating communication of data through one or more head nodes. The setup of determining which compute node(s) or sub-region(s) to access only needs to be done one time at the beginning of a transaction. Once the regional topology information is stored in the local regional hardware element, read and write requests are forwarded to one or more compute nodes by the regional hardware element(s).

As shown, initially, a data request for a dataset is received (702) by a head node manager in an analytics cluster, and the head node manager and direction manager ascertain the region layout for the cluster (704). The region layout pertains to routing information for the cluster. The head node manager is in communication with a first switch, and the head node manager places the layout routing information for the cluster in the first switch (706). With the cluster topography in the switch, it is determined if the cluster includes two or more regions of compute nodes (708). If at step (708) it is determined that there are a plurality of regions, for each region the local head node manager ascertains the layout of the compute node(s) and places the layout routing information for the region in the regional hardware element, e.g. switch, (710). Once the routing information is local to the regional hardware elements, data transfer from one or more compute node(s) to support the request is passed from the compute nodes to the requesting client via the local regional hardware element(s) (712), e.g. the data transfer is directly between regional hardware elements. However, if at step (708) it is determined that there is only one region, data in support of the read request is transferred directly from the compute node(s) in the region supporting the request through the switch to the requesting client (714). Accordingly, the data transfer in support of the read request is a direct communication between the compute node and the requesting client via the switch.

FIG. 7 illustrates support of a read request in the data analytics cluster. In one embodiment, the regional hardware element(s) store information received from the direction manager until it is invalid. When the regional hardware element receives any further read requests that are covered by this information, no further communication with the direction manager is needed. Accordingly, with the stored information, the regional hardware element(s) forwards the read request to the correct compute node or sub-region.

As shown in FIG. 5, each region in the cluster has a regional hardware element in communication with one or more head nodes. If at step (708) it is determined that the cluster includes at least two sub-regions, the regional hardware element in receipt of the read request ascertains which of the sub-regions can support the read request. In one embodiment, the sub-regions in the cluster are separate by performance locality and the selection of one or more compute nodes to support the request accounts for the performance locality aspect. Specifically, compute nodes may be selected based on workload characteristics, physical cluster architecture, data in specific sub-regions, e.g. byte range, directory, etc. to support the read request. The process of accessing the head node layout and compute node(s) to support the request is repeated until the appropriate compute node(s) in the cluster to support the request is ascertained. Once the appropriate compute node(s) is identified, the read request is supported by a direct communication between the requester and the final destination compute node(s). This direct communication is between the satisfying compute node(s) and the requesting client, and does not include buffering in the regional hardware element, as the data is passed immediately through the regional hardware element and back to the requester. Accordingly, one or more compute nodes satisfying the read request are located for direct communication with a requesting client.

As described above, the cluster may be segregated into regions, with each region having at least one compute node, a regional hardware element, a head node manager, and a direction manager. The regions may be organized based on various characteristics, including a hierarchical organization, administrative domain, workload characteristic, or physical characteristic of the selected node. In one embodiment, the compute nodes are separated into regions based on performance locality. Regardless of the structure, the head node manager, the direction manager, and the regional hardware element(s) function to ascertain the region(s) and compute node(s) to support the request. Accordingly, the compute nodes may be organized on a multi-dimensional basis, with the organization enabling efficient communication of data between the compute node(s) and the requesting client.

The analytics cluster supports write request and read requests, as demonstrated in FIGS. 6 and 7, respectively. The steps to support a write request are similar to the steps for supporting a read request. The difference is the write request is seeking a compute node to write the data to persistent storage, and specifically, the appropriate compute node based on characteristics of the write data or the requester of the write request. Similarly, the write data may be written on data storage of one compute node or multiple compute nodes, in a single region, or in multiple regions, etc. Both forms of requests enable reduction of workload on the head node(s) in the cluster.

As shown in FIG. 6 and FIG. 7, head nodes, head node managers, direction managers, and regional hardware elements are employed to enable the read or write request directly from a requesting entity to one or more compute nodes determined to support the request.

As demonstrated, direction (or re-direction) of read and write requests mitigates resources of the head node(s). Requests are directed to the compute node(s), or routed to the compute node(s). As shown, within the analytics cluster a hierarchical network topology may exist. Regardless of the position of the designated compute node(s) within the hierarchy, data packets are forwarded through nodes as necessary. With respect to the hierarchical organization of the region(s) and or compute node(s), the regional hardware element for each region understands the topology (via the redirection manager(s)) of the compute nodes within each region. The regional hardware element(s) account for network topology to support read and write requests. The cluster may contain semi-autonomous storage regions, with each region making decisions on how to layout data across the member compute nodes. However, regardless of the cluster architecture, the network layer as shown herein avoids inefficient protocol translation on the head nodes, and supports network efficiency.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the Figures illustrate the architecture, functionality, and operation of possible implementations of systems, methods and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated. Accordingly, the enhanced cloud computing model supports flexibility with respect to transaction processing, including, but not limited to, optimizing the storage system and processing transactions responsive to the optimized storage system.

### Alternative Embodiment(s)

It will be appreciated that, although specific embodiments of the invention have been described herein for purposes of illustration, various modifications may be made without departing from the spirit and scope of the invention. In one embodiment, it is understood that the configuration of the regions and the data stored local to the compute nodes of the regions is not static. To address the dynamic nature of the regions and the associated data, the head node for a select region can repeatedly instruct the regional hardware element in response to changes in data distribution. Similarly, in one embodiment, read requests are gathered together in a buffer, and a response is sent out to the client only once the read request is satisfied. The buffer supports a direct transfer of data between a requesting node and back end storage. The direct transfer is a series of steps to support the request without buffering data. In one embodiment, the head node layout is stored directly on a particular head node, thereby mitigating the need for a head node manager. Similarly, in one embodiment, the data transfer is a parallel data transfer with the regional hardware element for a region returning a layout which includes regional hardware elements to support the request. Use of file access protocols may be employed to read and write different byte ranges of a file from and to different regional hardware elements and compute nodes. Accordingly, the scope of protection of this invention is limited only by the following claims and their equivalents.

We claim:

1. A method comprising:
supporting read and write requests in and out of an analytics cluster, the analytics cluster including a distributed storage layout with a plurality of nodes separated into regions, at least one head node in communication with at least one compute node in each region, and each region having a hardware element in communication with the at least one head node;
storing request routing information in the regional hardware element;
directing data to support communication to one of the plurality of nodes in one of the regions through the regional hardware element, the directing in response to a directive from at least one head node, wherein the directing distributes the data to the cluster, including accounting for requirements of a supporting application while mitigating resource consumption to support a write request and providing direction to the regional hardware element of a select region to access an I/O request to support a read request; and
transferring data responsive to the data direction, wherein the transfer is direct to a compute node in the select region to support the write request and the transfer is a direction through the regional hardware element in the select region to support the read request.

2. The method of claim 1, further comprising organizing the regions into a hierarchical topology, each region including a separate regional hardware element to store request routing information that understands the topology of its nodes and sub-regions and data placement on those nodes and sub-regions to support data transfer.

3. The method of claim 2, further comprising separating the plurality of nodes into regions by a performance characteristic selected from the group consisting of: locality, administrative, security domain, and combinations thereof.

4. The method of claim 3, further comprising selecting a group of nodes to support the data transfer based on an attribute selected from the group consisting of: existing data placement, a workload characteristic, a physical attribute of the cluster, and combinations thereof.

5. The method of claim 1, wherein the data transfer is passed directly between regional hardware elements to support the request.

6. The method of claim 1, further comprising the data transfer accounting for one or more semi-autonomous storage regions in communication with the head node, and delegating direction to a selected storage region.

7. The method of claim 1, further comprising updating the regional hardware element in response to route information change for the region.

8. The method of claim 1, wherein the regional hardware element is selected from the group consisting of: a switch, an adapter, and a device driver.
